(19) United States
(12) Patent Application Publication
(10) Pub. No.: US 2006/0176845 A1
(43) Pub. Date: Aug. 10, 2006

(54) User equipment-based resource management method and system

(75) Inventor: Sinikka Sarkkinen, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/325,532

(22) Filed: Jan. 5, 2006

Related U.S. Application Data
(60) Provisional application No. 60/641,149, filed on Jan. 5, 2005.

(51) Int. Cl. H04Q 7/00

(52) U.S. Cl. 370/328

(57) ABSTRACT

A controller in a network manages resources to user equipment during data transmission. An uplink and a downlink are formed between the controller and the user equipment. The controller sends a last packet data unit to the user equipment that signals the end of transmission. Upon receipt, the user equipment sends an indicator to the controller to indicate a termination of the transmission in the uplink. The controller determines a traffic status in the downlink. The controller releases the resource according to the indicator and the traffic status.

### CROSS REFERENCE TO RELATED APPLICATIONS

This patent application claims priority under 35 USC § 119(e) to the following co-pending patent application: U.S. Provisional Patent Application Ser. No. 60/641,149, filed Jan. 5, 2005, entitled “User Equipment-Based Resource Management Method and System,” the contents of which are hereby incorporated by reference.

### BACKGROUND OF THE INVENTION

1. Field of the Invention

The present invention relates to managing network resources. More particularly, the present invention relates to managing network resources using user equipment to inform a network controller that resources are ready to be released.

2. Description of Related Art

As wireless communications become more prevalent, high speed data transmission between network resources is being addressed for various wireless network protocols and other standards. For example, a high-speed data channel having a high speed downlink packet access (HSDPA) allows user data transmission to occur in a downlink. A high peak rate in the channels may reach approximately 14.4 Mbit/sec, in a downlink direction. This peak rate may be higher than the support capability of current user equipment dedicated channels. Further, the trend of further defining high speed data rate channels seems to be continuing. For example, a new channel, referred to as high speed uplink packet access (HSUPA), may be provided. As HSDPA supports high peak data rates in the downlink channel, HSUPA and other newly defined channels should support high peak data rates in the uplink channel.

Channels having high peak data rates may seek to share air capacity between users or user equipment. User equipment accessing these channels also desire dedicated resources from UMTS terrestrial radio access network elements, including a radio network controller and base stations, from appropriate interfaces and from the base station. These resources may be reserved for the user equipment and applicable radio bearers until the call is considered finished and any resource release procedures have been performed. The resource release procedures ensure that proper utilization of the network resources is maintained.

Conventional control and release of resources include triggering the release of the resource in the radio network controller (RNC). This action may be an internal implementation within the RNC. The trigger uses an inactivity timer, or counter, in the RNC to detect inactive use of the assigned resources and channels, and to release any resources in those cases where the uplink and downlink channels are not being used. Timers, however, may not be suitable for high bit rate channels due to difficulty defining the optimal timer length and the burstness nature of packet-switched traffic.

Further, timers and counters may cause additional delays in releasing resources, which may lead to inefficient use of the resources in high bit rate channels. Moreover, when the utilization rate of the network is high, all additional delays to release unused resources may block the acceptance of new resource requests from new radio bearers that are assigned for other user equipments. This inefficiency may especially be true for air interface, base station and radio network controller resources.

A conventional approach to save resources on a high bit rate channel may assign normal data channel resources to an inactive radio access bearer. The assignment may occur when traffic on one or more channels drop under a certain level. The radio network controller, however, is forced to establish a new resource for the applicable user equipment, which results in an additional signal load on the network or system.

### SUMMARY OF THE INVENTION

An example of the preferred embodiments of the present invention includes a method for managing network resources. The method may include receiving an indication of a termination of a data transmission in an uplink from a user equipment. The method also may include determining a status for a downlink to the user equipment. The method also includes releasing a resource in response to the indication and the traffic status.

An embodiment of the invention includes a method for releasing a resource in a network. The method includes receiving a field in a packet from a controller. The method also includes determining the field indicates a termination of a channel from the controller to user equipment. The method also includes detecting a traffic status in a downlink within the channel. The method also includes starting a resource release procedure according to the termination and traffic status.

An embodiment of the invention includes a system for releasing resources in a network. The system includes receiving means for receiving a field in a packet data from a controller. The system also includes determining means for determining the field indicates a termination of a channel from the controller to user equipment. The system also includes detecting means for detecting a traffic status in a downlink within the channel. The system also includes starting means for starting a resource release procedure according to the termination and traffic status.

An embodiment of the invention includes a controller having means for receiving an indication of a termination of a data transmission in an uplink from user equipment. The controller also includes determining means for determining a traffic status for a downlink to the user equipment. The controller also includes releasing means for releasing a resource in response to the indication and traffic status.

An embodiment of the invention includes a system for controlling resource in a network. The system includes a controller to manage a resource in a network. The system also includes user equipment to exchange data with the controller over an uplink and a downlink. The resource is assigned to the user equipment. The system also includes an indicator to indicate a termination in the uplink. The controller releases the resource from the user equipment upon receipt of the indicator and a determination of a traffic status in the downlink.

An embodiment of the invention includes a method for releasing a resource. The method includes detecting an error in user equipment using a channel to exchange data with a controller. A resource is assigned to the user equipment. The method also includes generating a packet at the user equipment to indicate a termination of the channel based on the error. The method also includes sending the packet to the controller. The method also includes releasing the resource from the user equipment.

### BRIEF DESCRIPTION OF THE DRAWINGS

For proper understanding of the invention, reference should be made to the accompanying drawings, wherein:

FIG. 1 illustrates a block diagram of a network according to the present invention;

FIG. 2A illustrates a graph showing a timeline indicating resources being released in a network according to the present invention;

FIG. 2B illustrates a graph showing another timeline indicating resources being released in a network according to the present invention;

FIG. 3 illustrates a flowchart for managing resources in a network according to the present invention; and

FIG. 4 illustrates a flowchart for releasing a resource in a network according to the present invention.

### DETAILED DESCRIPTION OF THE PREFERRED EMBODIMENTS

Reference will now be made to the preferred embodiments of the present invention. Examples of the preferred embodiments are illustrated by the accompanying drawings.

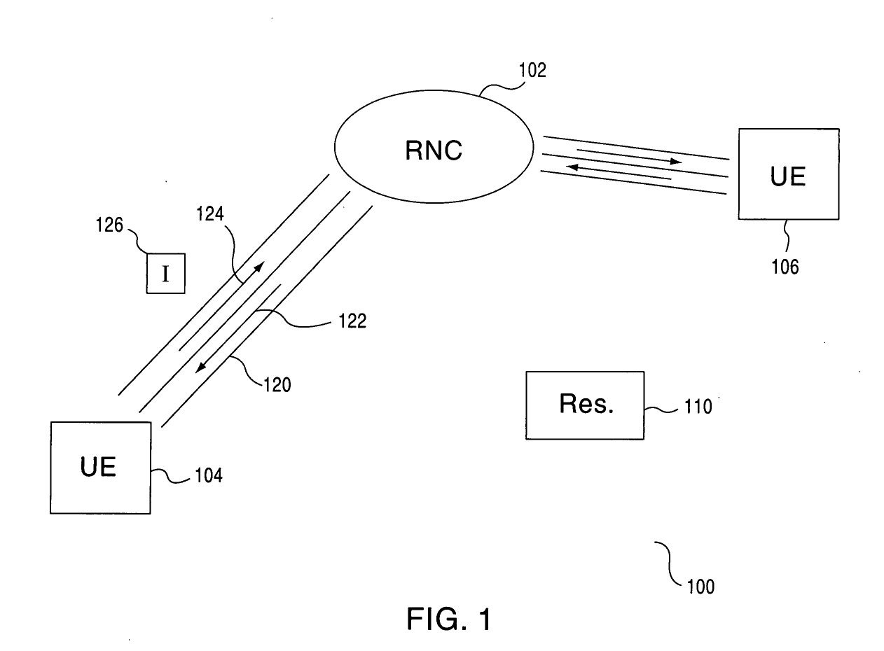

FIG. 1 depicts a block diagram of a network, or system, 100 having user equipment according to the present invention. Network 100 includes controller 102 and user equipment 104 and 106. Controller 102 may be a radio network controller. User equipment 104 and 106 may be portable communication devices, laptops, personal digital assistants, and the like. Network 100 also may include resource 110. Network 100 further may include additional controllers, user equipment, nodes, switches, resources and the like as desired.

User equipment 104 may establish channel 120 with controller 102. Channel 120 may include downlink channel path 120 and uplink channel path 124. Controller 102 may establish other channels with other user equipment, such as user equipment 106. Channel 120 may perform at a high peak data rate, such as approximately 14.4 Mbit/sec. Alternatively, channel 120 may perform at other data rates, greater or less than the example given above.

Network 100 may allow user equipment 104 to use an indication 126 to inform controller 102, or any other applicable controller, when an uplink data transmission is finished or completed. The uplink may be part of the data transmission channel between user equipment 104 and controller 102. Methods and processes may be defined to facilitate this communication from user equipment 104 to controller 102. After reception of indication 126 from user equipment 104, controller 102 may check the status of the downlink traffic in downlink channel path 122. If both the uplink and downlink directions are detected to be unused, then controller 102 may start resource release procedures immediately for resource 110. Alternatively, the traffic in the uplink and the downlink directions may be at a level acceptable for terminating the transmission or channel.

By receiving and using indication 126 from user equipment 104, controller 102 may optimize the use of resource 110. For example, resource 110 may be a radio access bearer-related resource. Resource 110 may be released from a radio bearer (RB) that does not desire resource 110 any longer. Controller 102 may assign resource 110, or any other applicable resource, to waiting RAB/RBs that are waiting to have access to network 100.

In order to release resource 110 immediately after the last uplink packet is sent from user equipment 104, user equipment 104 may use a method or process to inform controller 102 about the last packet in the uplink direction. This method or process may be defined to the corresponding user plane radio link control (RLC) layer that is capable of exchanging L2 level control information between peer RLC entities. Network 100, user equipment 104 and controller 102 may use different processes and methods to use the capability of the RLC layer to send control frames to inform network 100 and controller 102 about the ending of the uplink data transmission.

For example, a new uniform file identifier, or SUFI, may be defined to indicate the termination or ending of the uplink data transmission. Alternatively, the identifier may be known as a field with the last data packet or any other configuration, means, structure and the like to pass along information from user equipment 104 to controller 102. In the example, the SUFI may be referred to as an “END.” A currently used identifier, or field, such as “NO MORE” may be modified to incorporate the SUFI, and sent to controller 102 as a status packet data unit. Once received, controller 102 may analyze and determine that user equipment 104 has finished the uplink data transmission. According to the example, a new field may be added to the SUFI. Alternatively, a currently-used SUFI, such as “WINDOW,” may be used with value of 0 to indicate the end of the uplink data transmission.

Once controller 102 detects indication 126, information may be sent to a radio resource manager within network 100, or elsewhere, for further actions. If the radio resource manager or controller 102 determines that both directions of channel 120 are indicated to be inactive, then resources, such as resource 110, may be released without any additional delays. Thus, network resources may be released quickly due to user inactivity in the uplink, even though the downlink may still be open.

Controller 102 may determine whether downlink channel path, or downlink, 122 is unused. If so, no traffic should be present in the uplink or downlink direction of channel 120. Alternatively, resource 110 may be released or reconfigured even if existing data is detected in the downlink direction to user equipment 104. For example, an error may be detected in user equipment 104 that calls for a restart or reconfiguration. Any data received at or from user equipment may be corrupt. Thus, according to this example, even if traffic exists on downlink 122, transmission is terminated to user equipment 104.

Different values also may be defined into fields of the SUFI to provide information to controller 102, or commands from user equipment 104. Moreover, indication 126 may be used to request reconfiguration of channel 120, uplinks/downlinks to user equipment 104 and the like, especially if user equipment 104 has suffered an error that may not be recovered from with the reconfiguration. Thus, indication 126 and the sending of the SUFI from user equipment are not dependent on a lack of data transmission in the downlink direction, and may be used during other operations between controller 102 and user equipment 104. A fast reconfiguration may be started according to the present invention by user equipment 104 sending indication 126 that includes the proper commands, fields, and the like to request resource 110 be released.

Alternatively, the present invention may be applicable in cases where an error is detected or occurs with regard to user equipment 104. For example, a radio link may still be working, but for some reason, user equipment 104 does not want to continue the data transmission on channel 120. This kind of error case may be applicable in protocol layer error cases, on PDCP layer cases where the PDCP layer may not recover without a reset, and the like. In these instances, the layer on top of controller 102 may not work properly and, therefore, the correctness or integrity of the data may not be guaranteed. These situations may be resolved favorably by cutting the connection and forcing the subscriber or user or the system to re-establish the connection with a new configuration.

Thus, in the error case example, user equipment 104 may send indication 126 to controller 102, as discussed above. In the example, however, indication 126 may not correspond to a final data packet or end of transmission, but to the fact that an error has occurred and link should be cut. Instead of waiting for inactivity timers or other delays, controller 102 and network 100 may start resource release procedures immediately. Channel 120 may not be a high peak rate channel. A new SUFI also may be used in this example, because from the point of view of controller 102, the result is the same in that resources may be released upon receipt of an indication. The SUFI may include a field wherein the error indication is included.

User equipment 104 may desire an internal implementation to generate indication 126. For example, the RLC layer in user equipment 104 should be able to inform network 100 that transmission has finished. Thus, a procedure may be defined between an application server or network application server based on which the closing of the application may be detected. This feature may be useful when the use of an application, service or resource is totally finished. Another example may be when data transmission is stopped temporarily, such as due to a reading process. In this instance, it may be desirable to have a timer in user equipment 104 to trigger the transmission of indication 126, or another applicable indication, as soon as uplink traffic if finished. Thus, user equipment 104 may be changed faster to a specified state, and valuable DCH/HSDPA/HSUPA resources may be allocated to other users, user equipments, and the like.

Another aspect of managing network 100 may be when network 100 may have to take into account a plurality of the RLC entities configured in network 100 before making a decision if the uplink data transmission has stopped. For example, if there are 2 RLC entities or units, then the “END” indication may have to come from both entities. Each RLC, however, may send this indication separately because one RLC may serve one RAB and may have dedicated resources from controller 102 and other components, such as interfaces, within network 102. Further, because an RAB may have separate interface resources and RNC resources, these resources may be released upon receipt at the RNC, such as controller 102 from the appropriate user equipment. These resources then may be available to other users or user equipment.

Network 100 also may include user equipment 106. User equipment 106 may be a different type of user equipment from user equipment 104. For example, user equipment 106 may be from a different manufacturer than user equipment 104. Further, user equipments 104 and 106 may include different timers having periods of different lengths for inactivity. If these timer lengths in the user equipments are too long, then controller 102 may start the resource release based on its internal timers. Thus, current release procedures may not be necessarily removed from existing networks, but may be improved by implementing the present invention as discussed. Therefore, the present invention may be compatible with existing networks, controllers, user equipments and the like.

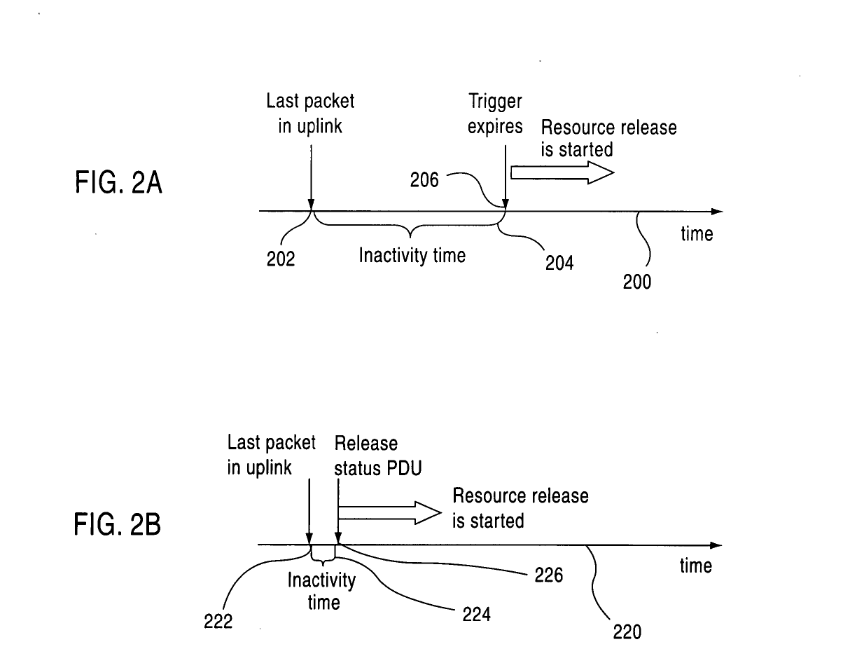

FIG. 2A depicts a graph showing a timeline 200 indicating resources being released in a network according to the present invention. Timeline 200 shows a process for releasing resources using a timer to determine inactivity time. The timer may be located in a controller, such as controller 102 of FIG. 1. Alternatively, the timer may be located in user equipment, such as user equipment 104 or 106 of FIG. 1. The timer may be implemented with other resource release processes, and may serve as a backup release process in the event other processes do not detect or determine the resource is ready to be released.

Time point, or time, 202 indicates when the last packet of a data transmission is received at a controller in the uplink direction. At time 202, a timer may start due to the inactivity on the link. The inactivity may continue for period 204. Period 204 may be the inactivity period or time delay between when the last packet is received, and when resources are starting to be released. Resources are reserved for the uplink despite not being used during period 204. Time point, or time, 206 indicates when the timer expires and a trigger for releasing resources to the uplink. Resources may not be released prior to time 206.

FIG. 2B depicts a graph showing another timeline 220 indicating resources being released in a network according to the present invention. Unlike timeline 200 of FIG. 2A, timeline 220 may not utilize a timer to determine when resources are to be released. Time 222 indicates when the last packet in a data transmission from a controller to user equipment is sent. Time period 224 starts and indicates the inactivity time when resources are reserved but not used in the uplink. Time period 224 may be the time delay between when the last packet is received, and when resources are starting to be released.

Time 226 indicates when the release status PDU is received with the indication that the uplink communication has terminated. Time 226 also indicates when the resources may start to be released. Time period 224 may be smaller than time period 204 because time 226 occurs without waiting on a timer, either in the controller or the user equipment. Time period 224 may be as long as it takes the user equipment to send back the indication that transmission is terminated. Timelines 200 and 220 may occur simultaneously such that resource release procedures are still started if there is a substantial delay in receiving the indication from the user equipment. Thus, resources are released even if no information is received from the user equipment based on a timer period or a timer expiring.

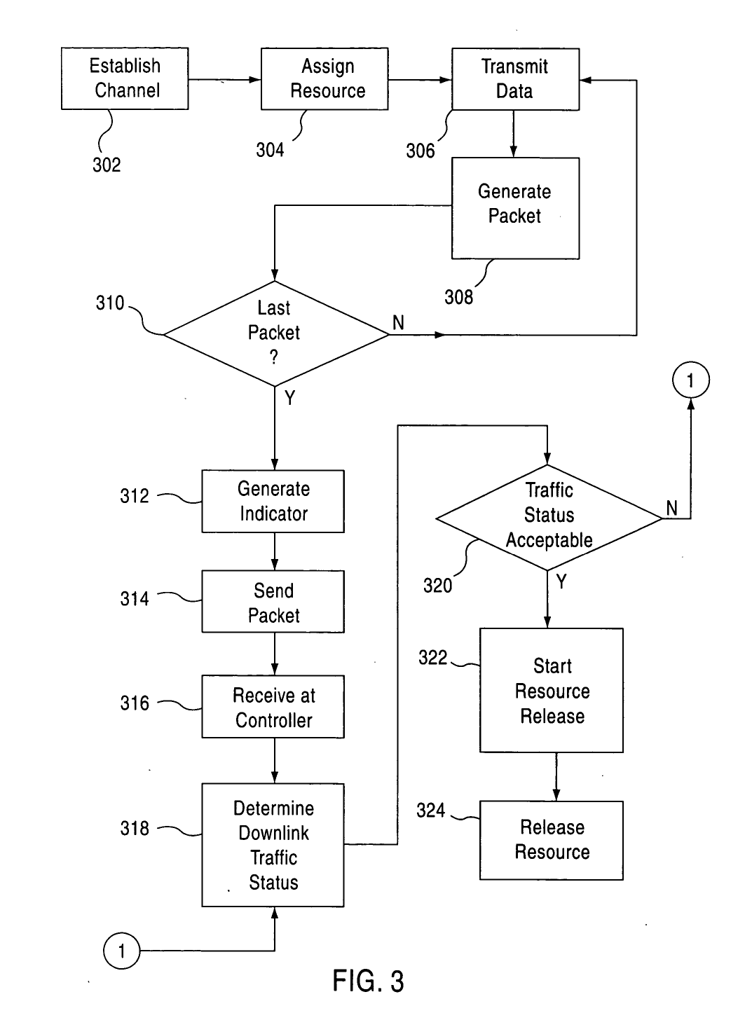

FIG. 3 depicts a flowchart for managing resources in a network according to the present invention. Step 302 executes by establishing a channel between a controller, such as a radio network controller, and user equipment. For example, referring to FIG. 1, channel 120 is established between controller 102 and user equipment 104. The established channel may support the exchange of data between the controller and the user equipment. The channel may includes an uplink and a downlink. The uplink and downlink may be known as links or paths. Step 304 executes by assigning a resource to the user equipment. For example, resource 110 of FIG. 1 may be assigned to user equipment 104. Resource 110 also may be assigned to other user equipment within the network. Alternatively, user equipment 104 may have more than one resource assigned to it.

Step 306 executes by transmitting data between the user equipment and the controller. Data may be exchanged as packets having a source and destination. The packets of data may include fields that carry different types of information according to where a field is located within the packet. The packets may be of any length, and are not limited in the number of fields. Step 308 executes by generating a packet to be exchanged over the channel. The packet may be generated by the user equipment to be sent to the controller in the uplink direction. The generated packet may include data to inform the controller about the status of the user equipment.

Step 310 executes by determining whether the packet is the last packet in the transmission. If no, then the packet is transmitted, and the process returns back to step 306. If step 310 is yes, then step 312 executes by generating an indicator of a termination of the uplink transmission. The indicator may be any value or field within the packet that is read by the controller to acknowledge that no further transmissions will be sent from the user equipment. Step 312 may modify an existing field within the packet, or add a new field. Further, a bit may be set within the packet to provide the indicator. For example, indicator 126 may be generated within user equipment 104 by setting a bit within the packet.

Step 314 executes by sending the packet with the indicator to the controller. Referring back to FIG. 1, for example, indicator 126 is sent from user equipment 104 to controller 102. Step 316 executes by receiving the indicator at the controller. The controller, such as controller 102, reviews the packet and is informed that a termination of the transmission in the uplink direction is to occur by the presence of the indicator.

Step 318 executes by determining a downlink traffic status. For example, controller 102 of FIG. 1 may determine the traffic status in downlink 122. Step 320 executes by determining whether the traffic status is acceptable. If the traffic status, or amount of traffic, in the downlink is acceptable, then resource release procedures may be started. This feature prevents the controller from releasing the resource prematurely. For example, referring to FIG. 1, controller 102 may receive indicator 126. Upon receipt, controller 102 determines a traffic status in downlink 122. The desired traffic status may be approximately zero (0), or no traffic, so that the resource is not released before the termination of the downlink transmission. In other words, when the transmission in the downlink direction is terminated, then the resource may be released, given that the uplink transmission is still terminated.

Step 332 executes by starting resource release within the controller. Resource release may be started once the controller determines that traffic in the downlink is almost non-existent, or below a level acceptable for termination. The controller also may wait to receive termination or indicators from other user equipments, as desired. For example, controller 102 may have to receive indicators from user equipments 104 and 106 before releasing resource 110. Step 324 executes by releasing the resource from the user equipment by the controller. The resource, such as resource 110, may be reassigned to additional user equipment. Thus, the resource is not wasted on a dead channel or during times when the channel must be taken down.

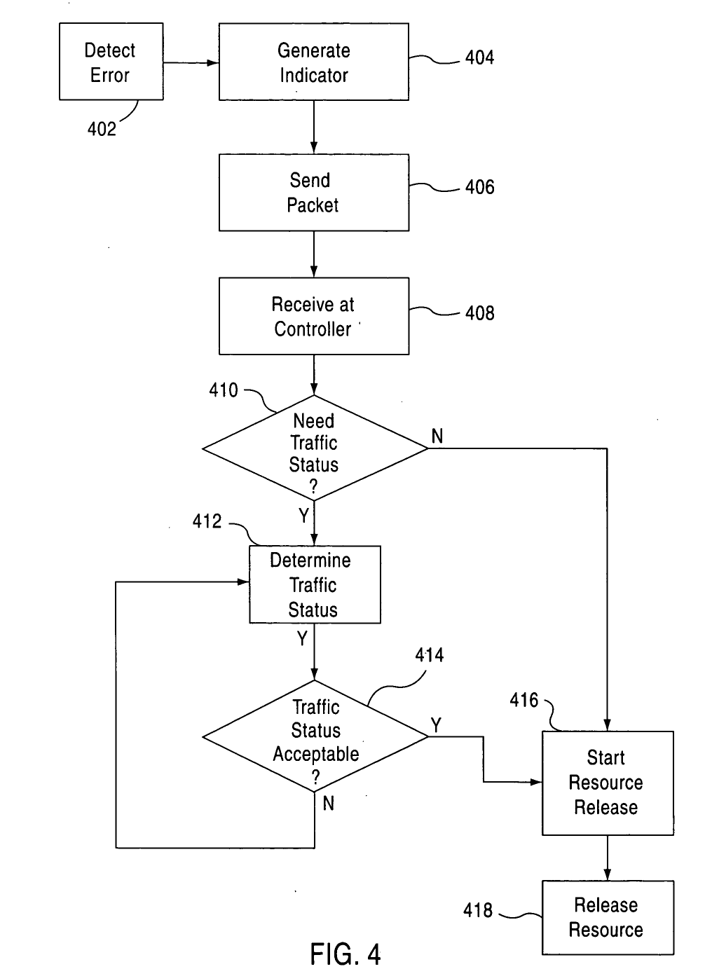

FIG. 4 depicts a flowchart for releasing a resource in a network according to the present invention. The resource may need to be released because of an error condition or other problem with the user equipment, the controller, the resource and the like. Step 402 executes by detecting an error. The error, or error condition, may compromise the transmission of data between the user equipment and the controller. For example, the power level may be under an acceptable level. The radio channel, or link, may be working, but the user equipment desires to terminate the data transmission on the channel. Another example may be a protocol layer error that requires a reset to recover. The integrity, or correctness, of the data cannot be guaranteed due to the error. Thus, it may be desirable to terminate the connection and force the subscriber or user equipment to re-establish the connection with a new configuration or channel.

Step 404 executes by generating an indicator. As discussed above, a field in a packet being sent to the controller may be modified to indicate that transmission should be terminated. The indicator may be the field, or a bit set in the field. Alternatively, a field may be added to the packet. As long as the controller can recognize that transmission is to be terminated, then the indicator is acceptable. Step 406 executes by sending the packet with the indicator to the controller from the user equipment. For example, referring to FIG. 1, user equipment 104 sends indicator 126 to controller 102.

Step 408 executes by receiving the packet including the indicator at the controller. Step 410 executes by determining whether a traffic status of the downlink is needed prior to termination. The traffic status may indicate, for example, that no traffic exists on the downlink and data transmission may not be compromised by terminating the channel. The controller also may desire to terminate the downlink and release the resource during a transmission, regardless of traffic. For example, the error condition may not allow for consideration of the downlink transmission, and the channel must be terminated immediately. Thus, if step 410 is no, then the flowchart proceeds to step 416, as discussed below.

If step 410 is yes, then step 412 is executed by determining a traffic status of the downlink. As discussed above, the traffic status may correspond to the amount of traffic on the downlink. Step 414 executes by determining whether the traffic status determined on the downlink is acceptable for termination. For example, the traffic status may indicate that no data traffic exists on the downlink and the transmission is not interrupted by terminating the link and releasing the resource. If no, then the flowchart returns back to step 412.

If step 414 is yes, then step 416 executes by starting the release resource procedures, for example, in the controller. Step 416 also may be executed if no traffic status is needed to be determined, as indicated in step 410. Step 418 executes by releasing the resource from being assigned to the user equipment. Referring back to FIG. 1, resource 110 is released by controller 102. Resource 110 may be re-assigned to user equipment 104 once a channel has been re-established after resolving the error. Alternatively, another resource may be assigned to user equipment 104.

Thus, resources may be released in those networks having high bit rate channels so that the resources are not wasted by being assigned to unused channels or inactive user equipment. Further, the network resources may be saved in error cases without waiting for timers to terminate the channel. As discussed above, a network may use a timer concurrently with the processes described in FIGS. 3 and 4. For example, if an error condition prevents the user equipment from sending a packet having an indicator to terminate the channel, then a timer at the controller may terminate the channel after a time period without unnecessarily waiting for the indicator.

The preferred embodiments of the present invention enable optimization of network resources. User equipment may inform the controller when the uplink data transmission is finished. This feature may be merged into the radio link control layer to promote increased simplicity in implementation. Further, reception of the termination, or end, of the service in the uplink direction allows the controller to release resources more quickly than conventional or known processes. If a resource is reserved for active radio access bearers, then limited resources in a network or system may be used more efficiently because resource release occurs as rapidly as possible.

The preferred embodiments, and the examples described above, of the present invention may be applicable for all channel types and not only for high bit rate channels. For instance, dedicated channels may be applicable that are managed by controllers. In error cases, user equipment may stop data transmission at any time and request termination and that a resource be released. Other applicable implementations may include any instance where user equipment may communicate directly with a controller to release a resource without waiting for a timer or inactivity period.

One having ordinary skill in the art will readily understand that the invention, and the preferred embodiments, as discussed above may be practiced with steps in a different order, or with hardware elements in configurations that are different than those that are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims and their equivalents.

1. A method for managing network resources, the method comprising:
receiving an indication of a termination of a data transmission in an uplink from user equipment;
determining a traffic status for a downlink to the user equipment; and
releasing a resource in response to the indication and the traffic status.

2. The method of claim 1, wherein said determining the traffic status includes detecting approximately no traffic on the downlink.

3. The method of claim 1, wherein said receiving the indication includes indicating the data transmission is finished.

4. The method of claim 1, wherein said receiving the indication includes indicating an error occurred in the user equipment.

5. The method of claim 1, further comprising receiving another indication from another user equipment.

6. The method of claim 1, further comprising detecting the uplink and the downlink are unused by the user equipment.

7. A method for releasing a resource in a network, the method comprising:
receiving a field in a packet from a controller;
determining the field indicates a termination of a channel from the controller to user equipment;
detecting a traffic status in a downlink within the channel; and
starting a resource release procedure according to the termination and traffic status.

8. The method of claim 7, wherein said detecting includes determining an amount of traffic on the downlink.

9. The method of claim 7, wherein said determining includes determining the termination of an uplink in the channel.

10. The method of claim 7, further comprising sending an indication of the termination from the user equipment to the controller.

11. A controller comprising:
receiving means for receiving an indication of a termination of a data transmission in an uplink from user equipment;
determining means for determining a traffic status for a downlink to the user equipment; and
releasing means for releasing a resource in response to the indication and traffic status.

12. The controller of claim 11, further comprising detecting means for detecting the uplink and the downlink are unused by the user equipment.

13. The controller of claim 11, wherein said receiving means includes indicating means for indicating the data transmission is finished.

14. A system for releasing resources in a network, the system comprising:
receiving means for receiving a field in a packet data unit from a controller;
determining means for determining the field indicates a termination of a channel from the controller to user equipment;
detecting means for detecting a traffic status in a downlink within the channel; and
starting means for starting a resource release procedure according to the termination and traffic status.

15. The system of claim 14, further comprising sending means for sending an indication of the termination from the user equipment to the controller.

16. A system for controlling resources in a network, the system comprising:
a controller to manage a resource in a network;
user equipment to exchange data with the controller over an uplink and a downlink, wherein the resource is assigned to the user equipment; and
an indicator to indicate a termination in the uplink,
wherein the controller releases the resource from the user equipment upon receipt of the indicator and a determination of a traffic status in the downlink.

17. The system of claim 16, wherein the indicator is included in a packet sent by the user equipment through the uplink.

18. A method for releasing a resource, the method comprising:
detecting an error in user equipment using a channel to exchange data with a controller, wherein a resource is assigned to the user equipment;
generating a packet at the user equipment to indicate a termination of the channel based on the error;
sending the packet to the controller; and
releasing the resource from the user equipment.

19. A user equipment comprising:
a transmitter for transmitting an indication of a termination of a data transmission to a controller, the user equipment being configured to exchange data with the controller over an uplink and downlink channel; and
a receiver for receiving a traffic status for the downlink channel from the controller;
wherein a resource is released from the user equipment in response to the indication and the traffic status.

20. The user equipment of claim 19, wherein the indication is included in a packet sent by the user equipment through the uplink.

21. The user equipment of claim 19, wherein the indication comprises indicating that the data transmission is finished.

22. The user equipment of claim 19, wherein the indication comprises indicating that an error occurred in the user equipment.

23. The user equipment of claim 19, wherein the indication comprises a determination of the termination of the uplink.

24. The user equipment of claim 19, wherein the traffic status comprises a determination of an amount of traffic on the downlink.

25. A user equipment comprising:
transmitting means for transmitting an indication of a termination of a data transmission to a controller, the user equipment being configured to exchange data with the controller over an uplink and downlink channel; and
receiving means for receiving a traffic status for the downlink channel from the controller;
wherein a resource is released from the user equipment in response to the indication and the traffic status.
